(19) United States
(12) Patent Application Publication
(10) Pub. No.: US 2026/0145269 A1
(43) Pub. Date: May 28, 2026

(54) MASK WRITING SYSTEM, BEAM SHAPING MODULE AND METHOD OF LASER BEAM PROCESSING

(71) Applicant: Applied Materials, Inc., Santa Clara, CA (US)

(72) Inventors: Michael Dongxue Wang, Tigard, OR (US); Lee Allen Sousley, West Linn, OR (US); Joshua Miles Lepley, Hillsboro, OR (US)

(73) Assignee: Applied Materials, Inc., Santa Clara, CA (US)

(21) Appl. No.: 18/962,044

(22) Filed: Nov. 27, 2024

(51) Int. Cl. B23K 26/06; B23K 26/066; B23K 26/082

(52) U.S. Cl. CPC B23K 26/0648; B23K 26/0643; B23K 26/066; B23K 26/0821

(57) ABSTRACT

A mask writing system may include a laser source to generate a laser beam, a multibeam modulator to receive an input laser beam and generate a plurality of modulated laser beams from the input laser beam, a scanner to direct the plurality of modulated laser beams to a mask holder, and a laser beam shaping module, disposed between the laser source and the multibeam modulator. As such, the laser beam shaping module may include a multi-lens system, disposed along a primary beam path. The multi-lens system may include a first lens to receive the laser beam and output a first converging laser beam; a second lens, arranged to receive the first converging laser beam and output a second converging laser beam; and a third lens, arranged to receive the second portion of the laser beam as a diverging beam, and to output a collimated beam to the multibeam modulator.

### FIELD

The present embodiments relate to laser processing tools, and in particular to laser mask writing systems.

### BACKGROUND

Photolithography provides tools and techniques for patterning the various layers and components that form electronic devices, micromechanical devices, and so forth. In the photolithography process, a mask layer of photosensitive material is deposited onto a substrate that is to be patterned, such as a semiconductor wafer. A photolithographic tool is used to expose predetermined areas of the photosensitive mask material in order to form a mask pattern onto the photosensitive layer (resist layer). After exposure, the photosensitive layer is “developed” and either the unexposed or the exposed regions (depending upon whether the resist layer is positive or negative) are removed leaving openings that allow further processing of the semiconductor wafer to take place. In known photolithography systems for patterning a substrate such as a semiconductor substrate, a pattern that is to be formed on the semiconductor substrate may be generated in the resist layer by transmitting the pattern onto the resist layer through a mask having the appropriate design.

In some examples, a photolithography mask for patterning semiconductor substrates may be reused multiple times to expose multiple wafers, so that the same pattern may be printed upon any suitable number of wafers using a given photolithography mask.

Photolithography masks may also be formed using a lithography process to create the mask pattern. In known technology for forming photolithography masks, a ‘writing’ tool, such as a laser apparatus, may be used to write a pattern onto photoresist in order to transfer the written pattern into an underlying mask layer, such as an opaque layer.

Known laser apparatus for mask writing may include an acousto-optic deflector (AOD) that receives a laser beam and generates a deflected beam, as well as diffractive elements that generates multiple beams from the deflected beam. The multiple beams may then be scanned over a mask surface using a polygon or an acousto-optic modulator. Any non-idealities in the size and shape of the laser beam may propagate through these different components, and may result in non-ideal patterning of the photolithography mask to be written.

With respect to these and other considerations the present embodiments are provided.

### BRIEF DESCRIPTION OF THE DRAWINGS

In one embodiment, a mask writing system is provided. The mask writing system may include a laser source to generate a laser beam, a multibeam modulator to receive an input laser beam and generate a plurality of modulated laser beams from the input laser beam, a scanner to direct the plurality of modulated laser beams to a mask holder, and a laser beam shaping module, disposed between the laser source and the multibeam modulator. As such, the laser beam shaping module may include a multi-lens system, disposed along a primary beam path. The multi-lens system may include a first lens to receive the laser beam and output a first converging laser beam; a second lens, arranged to receive the first converging laser beam and output a second converging laser beam; and a third lens, arranged to receive the second portion of the laser beam as a diverging beam, and to output a collimated beam as the input laser beam to the multibeam modulator.

In another embodiment, a method of controlling a laser beam is provided. The method may include directing the laser beam to a beam shaping module, focusing the laser beam in the beam shaping module at an intermediate image plane along a primary path, collimating the laser beam in the beam shaping module to form a collimated laser beam, and transmitting the collimated laser beam for receipt as an input laser beam at a multibeam modulator. As such, the beam shaping module may include a first lens to receive the laser beam and output a first converging laser beam, and a second lens, arranged to receive the first converging laser beam and output a second converging laser beam. The beam shaping module may further include a third lens, arranged to receive a portion of the laser beam as a diverging beam, and to transform the diverging beam into the collimated laser beam for receipt at the multibeam modulator.

In a further embodiment, a laser beam shaping-apparatus for a mask writing tool is provided. The laser beam shaping-apparatus may include a multi-lens system, arranged to receive a laser beam and process the laser beam along a primary beam path, and a movable mirror disposed along the primary beam path, the movable mirror being arranged to direct a first portion of the laser beam along a detector path. The laser beam shaping-apparatus may further include an imaging tool, disposed in the detector path to receive an image of the laser beam from the movable mirror. As such, the multi-lens system may include a first lens to receive the laser beam and output a first converging laser beam, a second lens, arranged to receive the first converging laser beam and output a second converging laser beam, and a third lens, arranged to receive the second portion of the laser beam as a diverging beam, and to output a collimated beam.

### BRIEF DESCRIPTION OF THE DRAWING

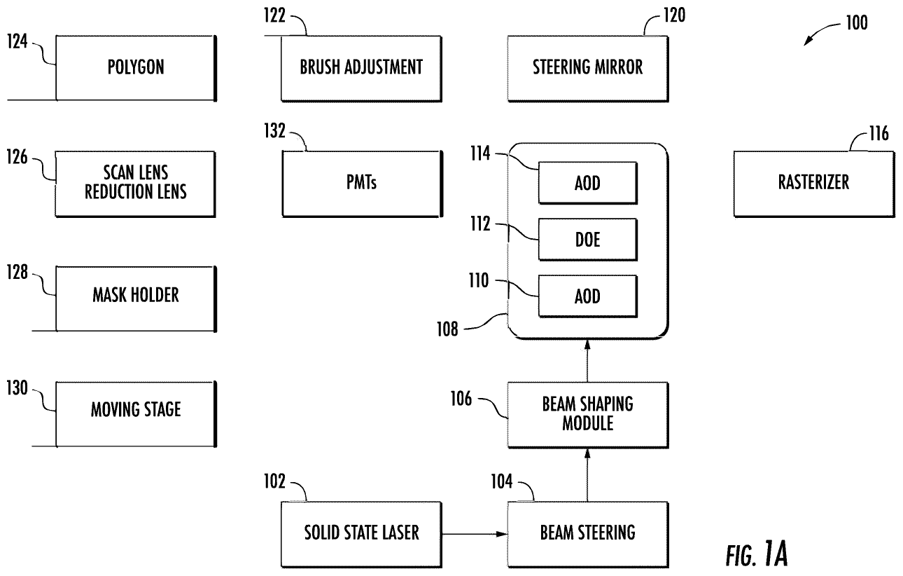

FIG. 1A presents a block diagram illustrating a laser processing system, according to various embodiments of the disclosure;

FIG. 1B, there is shown an example of the beam path of a laser beam for the laser processing system of FIG. 1A;

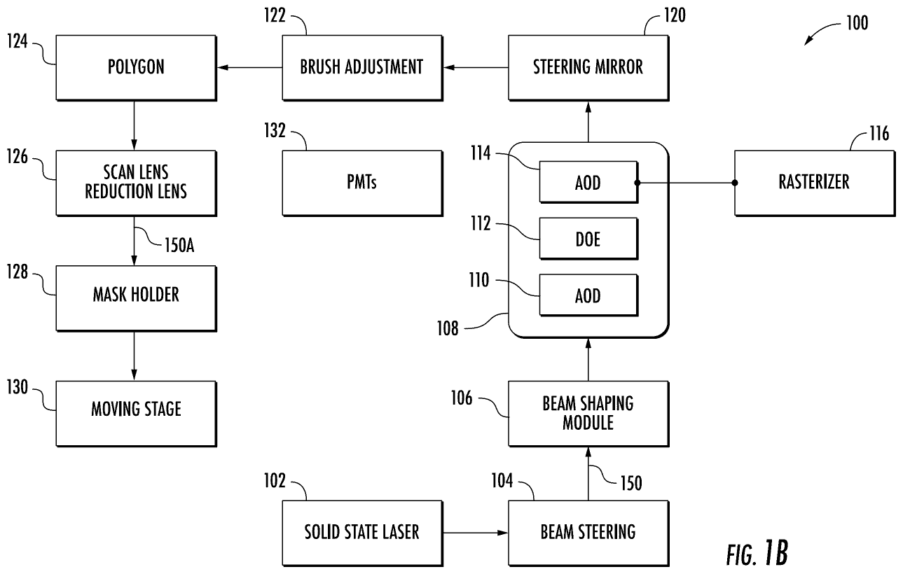

FIG. 2 depicts a laser beam processing arrangement according to embodiments of the disclosure.

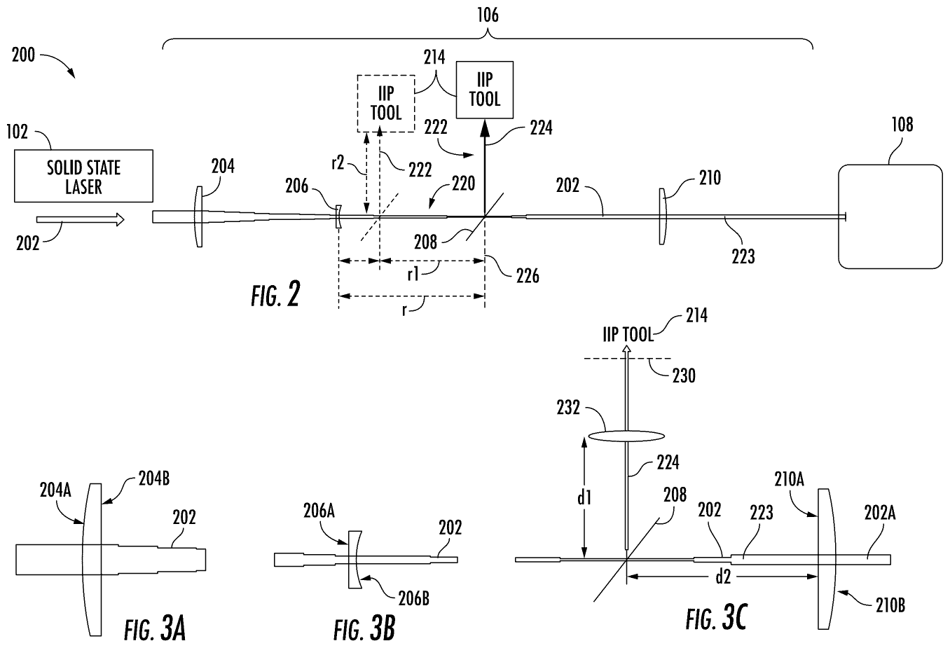

FIG. 3A, FIG. 3B, and FIG. 3C present details of the geometry of the beam shaping module shown in FIG. 2;

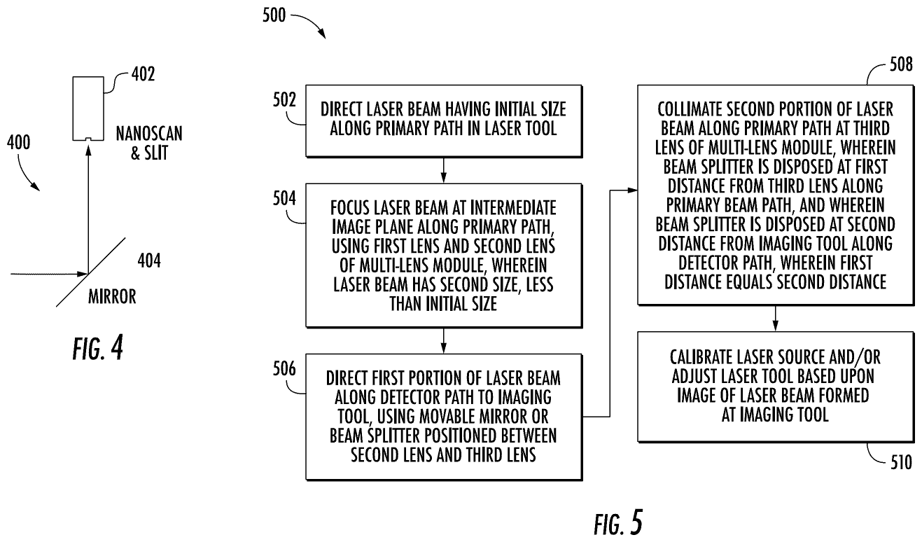

FIG. 4 shows on embodiment of an imaging tool; and

FIG. 5 presents an exemplary process flow, according to some embodiments of the disclosure.

### DETAILED DESCRIPTION

The present embodiments will now be described more fully hereinafter with reference to the accompanying drawings, where some embodiments are shown. The subject matter of the present disclosure may be embodied in many different forms and are not to be construed as limited to the embodiments set forth herein. Instead, these embodiments are provided so this disclosure will be thorough and complete, and will fully convey the scope of the subject matter to those skilled in the art. In the drawings, like numbers refer to like elements throughout.

The embodiments described herein relate to control and monitoring of laser beams in processing tools, such as lithography tools, including mask writers.

FIG. 1A presents a block diagram illustrating a laser processing system 100, according to various embodiments of the disclosure. The laser processing system 100 may include a laser source 102, to generate a laser beam at a suitable wavelength. In some examples, the wavelength may lie in the ultraviolet range, such as 257 nm according to one non-limiting embodiment. The laser processing system 100 may further include a beam steering component 104, a beam shaping module 106, a multibeam modulator 108, coupled to a rasterizer 116. The multibeam modulator 108 is arranged to receive a single laser beam as an input laser beam, to split the laser beam into multiple laser beams, and then modulate those multiple laser beams to generate multiple modulated laser beams. In various embodiments, to accomplish these operations, the multibeam modulator may be arranged with an acousto-optic deflector 110 (AOD) and a diffractive optical component 112 (DOE) to split the single laser beam into multiple laser beams, as well as an acousto-optic modulator 114 (AOM) to generate the multiple modulated laser beams.

The laser processing system 100 may further include a steering mirror 120, brush adjustment module 122, polygon 124, lens system 126, including a scan lens and reduction lens, mask holder 128, and movable stage 130. Save for the beam shaping module 106, the general function of the aforementioned components is known in the context of a laser writing tool, and will not be detailed in the description to follow, except as otherwise noted.

Turning to FIG. 1B, there is shown an example of the beam path of a laser beam for the laser processing system 100, according to embodiments of the disclosure. In operation, a laser beam 150 having a suitable wavelength and diameter is generated at the laser source 102, and directed and processed through the aforementioned components, discussed with respect to FIG. 1A. In brief, the laser beam 150 is directed through the beam shaping module 106, whose operation is detailed with respect to the embodiments to follow. The laser beam 150 is then provided as an input laser beam to the multibeam modulator 108, which module functions to fan-out the laser beam 150 into multiple beams as known in the art, which beams are not separately shown for clarity of illustration. A rasterizer 116 is provided to generate the signals that create the electrical signals that control the timing and intensity of the multiple beams of the laser beam 150 that are generated by the multibeam modulator 108.

After passing through a brush adjustment module 122, the laser beam 150 (now a plurality of modulated laser beams) is directed off the polygon 124 that acts as a beam scanner, using a rotating mirror or other suitable known component. Together with the scan lens and reduction lens of the lens system 126, the polygon 124 may write the plurality of scanned modulated laser beams 150A onto a mask to be patterned (not separately shown), which mask may be placed in a mask holder 128 that is coupled to the movable stage 130.

In operation, the beam shaping module 106 acts to transform and relay the shape of the laser beam 150, such as the laser Gaussian beam waist, to a desired location, and to resize the laser Gaussian beam waist as well. By way of further reference, in present day laser writing tools, the diffractive optical component, such as diffractive optical component 112 of multibeam modulator 108, is highly sensitive to laser beam quality and alignment, such as laser beam aberration, beam waist size and position. In accordance with the present embodiments, as detailed in the figures to follow, the beam shaping module 106 provides a more compact architecture that provides monitoring of the laser beam 150 by forming a virtual image that can be monitored, and whose position may be suitably adjusted by design of individual optical elements of the beam shaping module 106.

FIG. 2 depicts a laser beam processing arrangement 200 according to embodiments of the disclosure. This arrangement depicts the laser source 102, as well as details of an embodiment of the beam shaping module 106. FIG. 3A, FIG. 3B, FIG. 3C, and FIG. 3D depict an enlarged view of components of the beam shaping module 106 of FIG. 2. In this example, a laser beam 202 is generated and conducted into the beam shaping module 106. In this embodiment, the beam shaping module 106 includes a multi-lens system, comprising a plurality of lenses that are arranged to receive the laser beam 202 and process the laser beam 202 along a primary beam path 220, which beam path extends into the multibeam modulator 108.

The beam shaping module 106 also includes a movable mirror 208, disposed along the primary beam path 220. The movable mirror 208 is arranged to direct a first portion 224 of the laser beam 202 along a detector path 222, and to pass a second portion 223 of the laser beam 202 along the primary path 220, to be received by the multibeam modulator 108.

The beam shaping module 106 may further include an imaging tool 214, disposed in the detector path 222 to receive an image of the laser beam 202 from the movable mirror 208. According to some non-limiting embodiments, the imaging tool 214 may include a camera, a beam profiler, or a plano convex lens.

As further depicted in FIG. 2, in some embodiments, the multi-lens system of the beam shaping module 106 may include a first lens, shown as lens 204, a second lens, shown as lens 206, and third lens, shown as lens 210. This system of lenses may perform various processing and shaping operations on the laser beam 202, including reducing the laser Gaussian beam size, relaying the laser beam waist on the input of the multibeam modulator 108, and forming an intermediate image plane of the laser beam waist at a position between the lens 206 and the lens 210, which feature may be forwarded along the detector path 222 to the imaging tool 214. Note that the lens 204 and the lens 206 collectively translate and focus the original laser beam waist into an intermediate image plane (IIP) 226 for the laser beam 202, which plane is shown as coincident with the position of the movable mirror 208 in the embodiment of FIG. 2. However, in other embodiments, the movable mirror 208 may be moved closer to lens 206, so that the imaging tool 214 is arranged along a detector path 222 back by the dashed lines.

In the architecture of FIG. 2, the distance (along the primary beam path 220) between the lens 206 and IIP 226 is represented by r, which distance is fixed according to any particular set of lenses in the design of the multi-lens system. The distance between IIP 226 and the movable mirror 208 along the primary beam path 220 is represented by r1, while the distance between movable mirror 208 and the imaging tool 214 along the detector path 222 is represented by r2. The distance between lens 206 and movable mirror 208 is represented by r0. Therefore, r=r0+r1. For purposes of proper imaging of the beam 202, the distance r1+10 is set to equal r2+10, and therefore also equal to r. These equalities mean that the further the movable mirror 208 is disposed from the IIP 226, the larger the value of r1, the further the imaging tool 214 is placed from the movable mirror 208 (the larger the value of r2).

In various embodiments of the disclosure, the laser beam 202 is treated as a laser Gaussian beam, where the laser Gaussian beam is modeled according to Equations (1) and (2), where r denotes the beam radial size and z represents the beam propagation direction with beam waist located at the origin of the local coordinate, and the beam waist diameter is 2 wₒ, λ is the wavelength, such as 257 nm for this DUV solid state laser:

$$I ( r , z ) = {I}_{o} Exp ( - \frac{2 {r}^{2}}{{w ( z )}^{2}} ) \qquad ( 1 )$$

$$w ( z ) - {w}_{o} \sqrt{1 + {( \frac{λ z}{π {w}_{o}^{2}} )}^{2}} \qquad ( 2 )$$

In particular, the lens 204 and the lens 206 collectively work to translate and focus the original laser beam waist into an intermediate image plane (IIP), while the lens 210 further amplifies the IIP to form the desired the size of the Gaussian beam waist of laser beam 202 at the input of multibeam modulator 108. In particular, as more clearly illustrated in FIG. 3A, the first lens, lens 204, acts to receive the laser beam 202 and output the laser beam 202 as a first converging laser beam. In some non-limiting embodiments, the lens 204 is a plano convex lens, as illustrated in FIG. 3A. In particular, an entrance surface 204A of the lens 204 is convex, while an exit surface 204B is planar. Referring also to FIG. 2, the second lens, lens 206, is disposed along the primary beam path 220 before the movable mirror 208, and is arranged to receive the first converging laser beam from lens 204, and output a second converging laser beam, as shown in FIG. 3B. The lens 206 in this case may be a plano concave lens, where the entrance surface 206A is planar, and the exit surface 206B is concave.

Turning to FIG. 3C, the third lens, lens 210, is disposed after the movable mirror 208 along the primary beam path 220, and is arranged to receive a second portion of the laser beam 202, where a first portion 224 of the laser beam 202 is directed along the detector path 222 to the imaging tool 214. Note that the third lens, lens 210, is disposed after the focal plane of the laser beam 202, such that the second portion of the laser beam 202 is received as a diverging beam. As such, the lens 210 may be arranged as a second plano convex lens, to transform the diverging beam and output the diverging beam as a collimated beam, depicted in FIG. 3C. To accomplish this shaping, an entrance surface 210A is planar, while an exit surface 210B is convex. As such, the lens 210 may amplify the IIP to form a Gaussian beam waist of the laser beam 202 having the targeted size at the point of input into the multibeam modulator 108.

As a whole, the beam shaping module 106 may substantially reduce the laser Gaussian beam size of the laser beam 202. In some non-limiting examples, the laser Gaussian beam size may be reduced by a factor of 3×, a factor of 4×, or a factor of 5×. In one example, the Laser gaussian beam waist diameter may be reduced in size by 4.75×, from an initial 2 mm, when entering the beam shaping module 106, to 420 μm, where a 420 μm Gaussian beam waist size is more suitable for processing by the multibeam modulator 108, as compared to the larger beam size provided in known Laser writing tools.

As further depicted in FIG. 3C, the movable mirror 208 is located at IIP 226, and a relay lens 232 is provided to transfers the IIP image to the imaging tool 214 for measurement. The relay lens can be designed with unit magnification to duplicate the IIP that is located at the same position as the removable mirror 208 at imaging tool 214.

The relay lens 232 for an imaging tool 214 is located at a distance D1 from the movable mirror 208, while the movable mirror 208 is located at a distance D2 from the third lens, meaning lens 210. In one embodiment, the relay lens 232 may be designed with unity magnification equal to 1, to duplicate and relay the IIP to the imaging tool 214. In this embodiment, the relay lens 232 and the distance D1 need to be designed separately.

In another embodiment of the disclosure, the relay lens 232 may be set to be identical to lens 210. In this embodiment, with the relay lens 232 being identical to lens 210, the distance D1 is arranged to equal D2, meaning the relay lens 232 is spaced equally from the movable mirror 208 as compared to the spacing of movable mirror 208 from the lens 210. This equal spacing of relay lens 232 and lens 210 from movable mirror 208 ensures the beam size of the laser beam 202 at the imaging tool 214 is the exact same as the beam size of laser beam 202 at the output of lens 210 and the input to the multibeam modulator 108. The first portion 224 of the laser beam 202 at the imaging tool 214 thus presents an accurate representation of the portion of the laser beam 202 entering the multibeam modulator 108. Accordingly, in keeping with various embodiments of the disclosure, the beam image received at the imaging tool 214 may be used to accurately calibrate the laser source 102, as well as to diagnose potential problems with the laser processing system 100.

In accordance with some embodiments, the components of beam shaping module 106 may be zoomed (adjusted) so that the laser beam waist size at the intermediate image detection plane is either identical to the intermediate image plane, or the same as the laser beam waist at the input to the multibeam modulator 108. Moreover, the laser beam waist position may be adjusted as needed. A unique advantage of this beam shaping module 106 is to provide real time monitoring and controlling of the laser beam waist position and size at the input of the Multibeam modulator 108, which capability is useful to ensure laser beam quality and efficiency of the output of the multibeam modulator 108. The high quality of the laser beam output from the multibeam modulator 108 ultimately impacts the printing quality of a mask being processed by the laser processing system 100, since any potential laser beam degradation from the multibeam modulator 108 output, such as beam waist position and size mismatch, improper collimation, etc., from the multibeam modulator 108 will be further accumulated and amplified by the pre-scan optics located after the multibeam modulator 108, scanning polygon (polygon 124), and post-scan optics. In addition to the features detailed above, the beam shaping module 106, including a three-lens optical system, affords the ability to correct the astigmatism aberration and beam ellipticity of a solid state laser through the design and optimization each of lens as well as the design of the separation between lenses. In particular embodiments, to provide these corrections, an aspherical lens or free-form optics may be utilized.

According to various embodiments of the disclosure, the lens components of the beam shaping module 106 may be formed of a monolithic structure of a suitable optical material, such as fused silica. Examples of suitable lens material include commercially available fused silica, such as Corning® HPFS® 7980, or 7979, 8655 Fused Silica (registered trademark of Corning, Inc.). For example, the refractive index of these materials is 1.506, while the thermal coefficient is 13.9.

In one non-limiting embodiment, the three lenses of a multi-lens system may be configured as follows: A three-lens system is arranged into two groups: Group 1 formed from lens 204 and lens 206, and Group 2, represented by lens 210. The focal length of the three-lens system provide a focal length or FL of 14275.71 mm, and a back focal length BFL of 2898.29 mm. Group 1 generates a composite focal length f1 of 408.40 mm, while Group 2 has a focal length f2 of 85.36 mm. These focal lengths satisfy the following inequality conditions:

$$4.7 < f 1 / f 2 < 4.9 ,$$

$$34 < FL / f 1 < 350 ,$$

$$165 < FL / f 2 < 1640 ,$$

$$and$$

$$0.195 < BFL / F < 0.215 .$$

Tables I-IV present design recipes that include further select properties of multi-lens systems arranged according to the present embodiments, including properties for the first lens, second lens, and third lens. The tables include exemplary physical values for lenses, including the radii, thickness, and materials of different lenses. The tables further provide examples of optical properties of the multi-lens systems, including FL, BFL, and the composite focal lengths for the first lens and second lens (acting as a first lens group) and focal length for the third lens, represented by the parameters f1 and f2, respectively. In the example of table I, the lens design recipe generates an FL of 14,275.71 mm, and BFL of 2,898.29 mm. Various ratios of design parameters are also shown including f1/f2, FL/f1, FL/f2, and BFL/FL. The Material C79-80 is glass material, fused silica from Corning HPFS 7980.

TABLE I

| Surface | Radius (mm) | Thickness (mm) | Materials |
|---|---|---|---|
| 0 | Infinity | Infinity | Air |
| 1 (Stop/Laser) | Infinity | 1000 | Air |
| 2 (Lens 1) | 37.8 | 3.5 | C79-80 |
| 3 | Infinity | 58.413 | Air |
| 4 (Lens 2) | Infinity | 2.0 | C79-80 |
| 5 | 8 | 67.965 | Air |
| 6 (IIP) | Infinity | 83.307 | Air |
| 7 (Lens 3) | Infinity | 3.3 | C79-80 |
| 8 | −43 | 91.515 | Air |
| 9 (AOD) | Infinity | | |

In the example of table II, the lens design recipe generates an FL of 14,594.42 mm, and BFL of 2,921.03 mm.

TABLE II

| Surface | Radius (mm) | Thickness (mm) | Materials |
|---|---|---|---|
| 0 | Infinity | Infinity | Air |
| 1 (Stop/Laser) | Infinity | 1000 | Air |
| 2 (Lens 1) | 37.8 | 3.529 | C79-80 |
| 3 | Infinity | 58.543 | Air |
| 4 (Lens 2) | Infinity | 1.714 | C79-80 |
| 5 | 8 | 69.121 | Air |
| 6 (IIP) | Infinity | 84.282 | Air |
| 7 (Lens 3) | Infinity | 2.019 | C79-80 |
| 8 | −43 | 96.092 | Air |
| 9 (AOD) | Infinity | | |

In the example of table III, the lens design recipe generates an FL of 15.331.97 mm, and BFL of 3.102.63 mm.

TABLE III

| Surface | Radius (mm) | Thickness (mm) | Materials |
|---|---|---|---|
| 0 | Infinity | Infinity | Air |
| 1 (Stop/Laser) | Infinity | 1000 | Air |
| 2 (Lens 1) | 37.8 | 3.5 | C79-80 |
| 3 | Infinity | 58.585 | Air |
| 4 (Lens 2) | Infinity | 1.67 | C79-80 |
| 5 | 8 | 68.625 | Air |
| 6 (IIP) | Infinity | 83.249 | Air |
| 7 (Lens 3) | Infinity | 3.3 | C79-80 |
| 8 | −43 | 99.371 | Air |
| 9 (AOD) | Infinity | | |

In the example of table IV, the lens design recipe generates an FL of 91.010.53 mm, and BFL of 19.298.65 mm.

TABLE IV

| Surface | Radius (mm) | Thickness (mm) | Materials |
|---|---|---|---|
| 0 | Infinity | Infinity | Air |
| 1 (Stop/Laser) | Infinity | 1000 | Air |
| 2 (Lens 1) | 13.959 | 3.407 | C79-80 |
| 3 | Infinity | 9.987 | Air |
| 4 (Lens 2) | Infinity | 1.531 | C79-80 |
| 5 | 8.136 | 135.787 | Air |
| 6 (IIP) | Infinity | 49.170 | Air |
| 7 (Lens 3) | Infinity | 10.000 | C79-80 |
| 8 | −28.000 | 79.581 | Air |
| 9 (AOD) | Infinity | | |

The present embodiments cover lens systems providing an f1 that covers at least between 261 mm and 414 mm, an f2 between at least 55.6 and 85.4 mm, an FL at least between 14276 mm and 91011 mm, and a BFL at least between 2898 mm and 19299 mm. Moreover, the present embodiments cover f1/f2 ratios ranging at least between 4.702 and 4.855, FL/f1 ratios ranging at least between 34.956 and 348.22, FL/f2 ratios at least between 167.25 and 1637.5, and BFL/FL ratios at least between 0.2001 and 0.2120.

FIG. 4 shows on embodiment of an imaging tool 400 having a scanning slit 402 and mirror 404. The imaging tool 400 may be a NanoScan 2s Si/9/5, Silicon Scanning Slit Beam Profiler with 5 μm split size, or other equivalent laser beam profiler.

FIG. 5 presents an exemplary process flow 500, according to some embodiments of the disclosure.

At block 502 a laser beam is directed from along a primary path in a laser processing tool. The laser beam may be characterized by an initial size, such as a laser Gaussian beam size.

At block 504, the laser beam is focused on an intermediate image plane along the primary path, using a first lens and a second lens of a multi-lens module. As such, the laser beam is reduced to a second size, less than the initial size.

At block 506, a first portion of the laser beam is directed along a detector path to an imaging tool, using a or switchable/movable Mirror or a beam splitter positioned between the second lens and the third lens. In one embodiment, the movable mirror may be arranged to deflect the first portion at a right angle with respect to the main path, along a detector path.

At block 508, a second portion of the laser beam is collimated along the primary path at a third lens of multi-lens module. The laser beam may enter the third lens as a diverging beam, for example. As a whole the multi-lens system may reduce the laser Gaussian beam waist size by a factor up to 4.75× at the Multibeam modulator, according to some embodiments. In one embodiment, the laser Gaussian beam waist size may be reduced to 66 μm in size at IIP

In particular embodiments, the movable mirror may be disposed at a first distance from the third lens along the primary beam path, while the movable mirror is disposed at a second distance from a relay lens that is disposed along the detector path, where the first distance equals the second distance.

At block 510 the laser source is calibrated and/or the laser tool is adjusted based upon an image of the laser beam formed at the imaging tool. Note that in the aforementioned embodiments, the movable mirror may be removed from the primary beam path in a writing tool before actual laser writing is to take place, such that a laser beam is propagated from laser source to multibeam modulator while not encountering the movable mirror.

Advantages provided by the present embodiments for processing a laser beam in a writing tool are manifold. As a first advantage, the beam shaping module facilitates a more compact system design, by forming a virtual image of the initial laser beam waist, where the imaging distance of the virtual image can be adjusted by design of each lens, and the separation between lenses. Moreover, the laser beam shaping module of the present embodiments provides a matching of the size and position of the laser Gaussian beam waist from the laser source to the lithography module of the laser writing tool. This Gaussian beam waist matching strongly impacts the critical dimension of lithographic features, as well as the overall optical efficiency of the lithography module, and therefore the overall laser writing tool, particularly in the case where the lithography module includes diffractive optics.

The present disclosure is not to be limited in scope by the specific embodiments described herein. Indeed, other various embodiments and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, the present disclosure has been described herein in the context of a particular implementation in a particular environment for a particular purpose, yet those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

What is claimed is:

1. A mask writing system, comprising:
a laser source to generate a laser beam;
a multibeam modulator to receive an input laser beam and generate a plurality of modulated laser beams from the input laser beam;
a scanner to direct the plurality of modulated laser beams to a mask holder; and
a laser beam shaping module, disposed between the laser source and the multibeam modulator, the laser beam shaping module comprising:
a multi-lens system, disposed along a primary beam path and comprising:
a first lens to receive the laser beam and output a first converging laser beam;
a second lens, arranged to receive the first converging laser beam and output a second converging laser beam; and
a third lens, arranged to receive the laser beam as a diverging beam, and to output a collimated beam as the input laser beam to the multibeam modulator.

2. The mask writing system of claim 1, the laser beam shaping module further comprising:
a movable mirror disposed along the primary beam path, the movable mirror being arranged to direct the laser beam along a detector path; and
an imaging tool, disposed in the detector path to receive an image of the laser beam from the movable mirror.

3. The mask writing system of claim 2, wherein the imaging tool comprises a camera, a beam profiler, or a plano convex lens.

4. The mask writing system of claim 2, wherein the movable mirror is disposed at a first distance from the third lens along the primary beam path, and wherein the movable mirror is disposed at a second distance from a relay lens that is disposed along the detector path, wherein the first distance equals the second distance.

5. The mask writing system of claim 2, wherein the multi-lens system comprises:
a first plano convex lens, disposed to receive the laser beam from a laser source;
a plano concave lens, disposed after the first plano convex lens along the primary path, and before the movable mirror; and
a second plano convex lens, disposed after the movable mirror along the primary beam path.

6. The mask writing system of claim 1, wherein the first lens and the second lens are configured to reduce a Gaussian beam size of the laser beam by a factor of 4× or greater.

7. The mask writing system of claim 1, wherein the first lens and the second lens are configured to form an intermediate image plane of a laser beam waist of the laser beam between the second lens and the third lens.

8. The mask writing system of claim 1, wherein the first lens and the second lens comprise a first lens group, wherein the multi-lens system is configured to generate a focal length FL of approximately 14200 mm to 91000 mm, and a back focal length BFL of approximately 2900 mm to 19,300 mm.

9. The mask writing system of claim 8, wherein the first lens group is configured to generate a composite focal length f1 ranging between 260 mm 410 mm, and wherein the third lens is configured to generate a focal length f2 of 55 mm to 85 mm.

10. The mask writing system of claim 1, wherein the first lens and the second lens comprise a first lens group, wherein the multi-lens system is characterized by a focal length FL and a back focal length BFL, wherein the first lens group is characterized by a composite focal length f1, wherein the third lens is characterized by a focal length f2, and wherein:
$$4.7 < f 1 / f 2 < 4.9 ,$$
$$34 < FL / f 1 < 350 ,$$
$$165 < FL / f 2 < 1640 , and$$
$$0.195 < BFL / F < 0.215 .$$

11. A method of controlling a laser beam, comprising:
directing the laser beam to a beam shaping module;
focusing the laser beam in the beam shaping module at an intermediate image plane along a primary path;
collimating the laser beam in the beam shaping module to form a collimated laser beam; and
transmitting the collimated laser beam for receipt as an input laser beam at a multibeam modulator,
wherein the beam shaping module comprises:
a first lens to receive the laser beam and output a first converging laser beam;
a second lens, arranged to receive the first converging laser beam and output a second converging laser beam; and
a third lens, arranged to receive a portion of the laser beam as a diverging beam, and to transform the diverging beam into the collimated laser beam for receipt at the multibeam modulator.

12. The method of claim 11, wherein the first lens and the second lens form an intermediate image plane of a laser beam waist of the laser beam between the second lens and the third lens.

13. The method of claim 11, further comprising:
directing a first portion of the laser beam along a detector path using a movable mirror that is positioned between the second lens and the third lens;
and
receiving an image of the laser beam from the movable mirror at an imaging tool, disposed in the detector path.

14. The method of claim 13, wherein the imaging tool comprises a camera, a beam profiler, or a plano convex lens.

15. The method of claim 13, wherein the movable mirror is disposed at a first distance from the third lens along the primary beam path, and wherein the movable mirror is disposed at a second distance from a relay lens that is disposed along the detector path, wherein the first distance equals the second distance.

16. The method of claim 13, wherein the first lens, the second lens, and the third lens form a multi-lens system that comprises:
a first plano convex lens, disposed to receive the laser beam from a laser source;
a plano concave lens, disposed after the first plano convex lens along the primary path, and before the movable mirror; and
a second plano convex lens, disposed after the movable mirror along the primary beam path.

17. The method of claim 11, wherein the first lens and the second lens reduce a Gaussian beam size of the laser beam by a factor of 4× or greater.

18. A laser beam shaping-apparatus for a mask writing tool, comprising:
a multi-lens system, arranged to receive a laser beam and process the laser beam along a primary beam path;
a movable mirror disposed along the primary beam path, the movable mirror being arranged to direct a first portion of the laser beam along a detector path; and
an imaging tool, disposed in the detector path to receive an image of the laser beam from the movable mirror, wherein the multi-lens system comprises:
a first lens to receive the laser beam and output a first converging laser beam;
a second lens, arranged to receive the first converging laser beam and output a second converging laser beam; and
a third lens, arranged to receive the laser beam as a diverging beam, and to output a collimated beam.
